(19) United States
(12) Patent Application Publication
(10) Pub. No.: US 2008/0131139 A1
(43) Pub. Date: Jun. 5, 2008

(54) Optical data link stably operable for duplicated reset

(75) Inventor: Hiroto Ishibashi, Kanagawa (JP)

Correspondence Address: VENABLE LLP, P.O. BOX 34385, WASHINGTON, DC, 20043-9998, US

(73) Assignee: Sumitomo Electric Industries, Ltd., Osaka (JP)

(21) Appl. No.: 11/978,711

(22) Filed: Oct. 30, 2007

(30) Foreign Application Priority Data
Oct. 30, 2006 (JP) 2006-294681

(51) Int. Cl. H04B 10/00

(52) U.S. Cl. 398/155

(57) ABSTRACT

The preset invention provides an optical data link that prevents the internal I2C bus system from being hung up. The data link provides a CPU able to receive a reset signal and an IC (PHY) to control the physical layer to communicate with the outside of the data link, and they are coupled via the internal I2C bus system. When the data link receives a reset signal, the PHY behaves as the slave device, while, the controller behaves as the master device to output dummy clocks on the clock line of the I2C bus so as to sweep left data on the data line of the I2C bus.

### BACKGROUND OF THE INVENTION

1. Field of the Invention

The present invention relates to an optical data link that provides an optical transmitting section and an optical receiving section.

2. Related Prior Art

Japanese Patent Application published as JP-2006-099410A has disclosed an optical data link that provides an IC for controlling a physical layer to communicate with the outside of the data link, which is often denoted as PHY, an electrical erasable programmable memory (EEPROM) that holds data and coupled with the PHY via the internal serial communication bus, and the transmitting and receiving section. In such a data link, initializing the optical transceiver triggered by the RESET provided outside of the data link, the internal serial bus becomes active and the data to be treated in the initializing process are read out from the memory. When the external apparatus coupled through the external serial communication line requests the internal bus by the software RESET during the initializing process of the data link, a bus collision may occur and accordingly the data link becomes instable.

The conventional data link disclosed in the Japanese Patent above, when the data link receives the external software RESET, is forced to output the serial clock for the internal serial bus from the PHY to prevent the internal bus from being inoperable.

However, an extreme case may occur in which further hardware RESET is asserted during the initializing process by the software RESET. The internal serial bus may be unstable for such double resetting procedure, and the conventional data link has provided no means to respond such double requests.

### SUMMARY OF THE INVENTION

One of aspects of the present invention relates to a configuration of an optical data link. The data link includes a controller, an IC, a memory and an I2C bus system. The controller controls the operation of the data link and has a function to receive the reset from the outside of the data link. The IC controls the physical layer to communicate with the outside of the data link. The memory holds data to initialize the IC. The I2C system couples the controller, the IC and the memory.

The controller according to the present invention has a feature that, when the controller receives the reset signal from the outside of the data link, the controller temporarily behaves as a master device of the I2C bus system, while, the IC behaves as the slave device of the I2C bus. The controller further operates to output a series of clocks on the clock line of the I2C bus to sweep data left on the data line of the I2C bus system. The count of clocks output from the controller is at least one count more than the counts contained in a packet data normally transmitted on the data line of the I2C bus system.

The present data link may operate in stable even the duplicate reset status occurs, that is, even an additional reset signal is received during the procedure in the reset status, because the left data on the data line of the I2C bus system are swept by temporarily clocks output from the controller.

Another aspect of the present invention relates to a method to control a duplicate reset status of the optical data link. The method includes; (a) changing the controller to a master device and the IC to a slave device of the I2C bus system when the controller receives an additional reset signal during the reset procedure, (b) the controller outputting a series of dummy clocks on the data line of the I2C bus to sweep the left data on the I2C bus; and (c) changing the controller to the slave device and the IC to the master device of the I2C bus system. The count of the dummy clock output from the controller during the step (b) may be at least one count more than the counts contained in the packet data normally transmitted on the data line of the I2C bus system.

Because the data left on the data line at the acceptance of the duplicate reset signal may be swept by the dummy clock output from the controller; no data is left on the data line after the step (b) above. Thus, the data link may securely recover from the reset procedure.

### BRIEF DESCRIPTION OF DRAWINGS

FIG. 1 illustrates a block diagram of an optical data link according to an embodiment of the present invention;

FIG. 2 is a time chart of respective signals when the optical data link shown in FIG. 1 receives a hardware RESET signal;

FIG. 3 illustrates a block diagram of a conventional optical data link; and

FIG. 4 is a time chart of respective signals when the optical data link shown in FIG. 3 receives a hardware RESET signal.

### DESCRIPTION OF PREFERRED EMBODIMENTS

Next, preferred embodiments of the present invention will be described as referring to accompanying drawings.

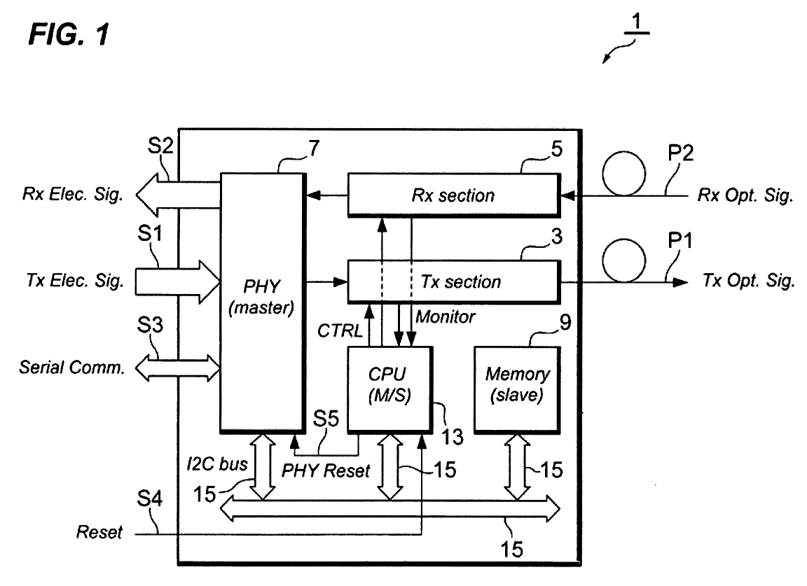

FIG. 1 illustrates a block diagram of an optical data link according to an embodiment of the invention. The data link shown in FIG. 1, which is coupled with a host system (not shown in FIG. 1), converts a transmitting electrical signal S1 to a transmitting optical signal P1 to output from the transmitter section 3, and converts a receiving optical signal P2 received by the receiver section 5 to a receiving electrical signal S2. The transmitter section 3 includes a transmitter optical subassembly (TOSA) that installs a semiconductor laser diode, while the receiver section 5 includes a receiver optical subassembly (ROSA) that installs a photodiode.

The data link 1 shown in FIG. 1 further provides an IC 7 configured to manage the communication of the transmitter and receiver sections, 3 and 4, with the external devices, or with the host system, which is often calls as the PHY, a memory 9 for storing data to initialize the PHY 7, and a processor CPU 13 to control the each block within the data link 1. These devices, the PHY 7, the memory 9 and the CPU 13, are connected with the I2C bus 15. The PHY 7 operates as a master device while the memory 9 and the CPU 13 operate as the slave devices under a normal operation. That is, the PHY arbitrates the I2C bus.

The CPU 13, receiving the monitor signals from the transmitter section 3 and the receiver section 5, controls sections, 3 and 5, by sending control signals. Moreover, the CPU 13 may communicate with the host system through the PHY 7 by sending the status of the data link 1 thereto and by receiving instructions therefrom.

Next, the hardware RESET of the data link 1 will be described. Receiving the hardware RESET signal S4 from the host system, only the CPU 13 may receives this RESET signal S4. Then, the CPU 13 generates the PHY RESET signal S5 and sends this signal S5 to the PHY 7.

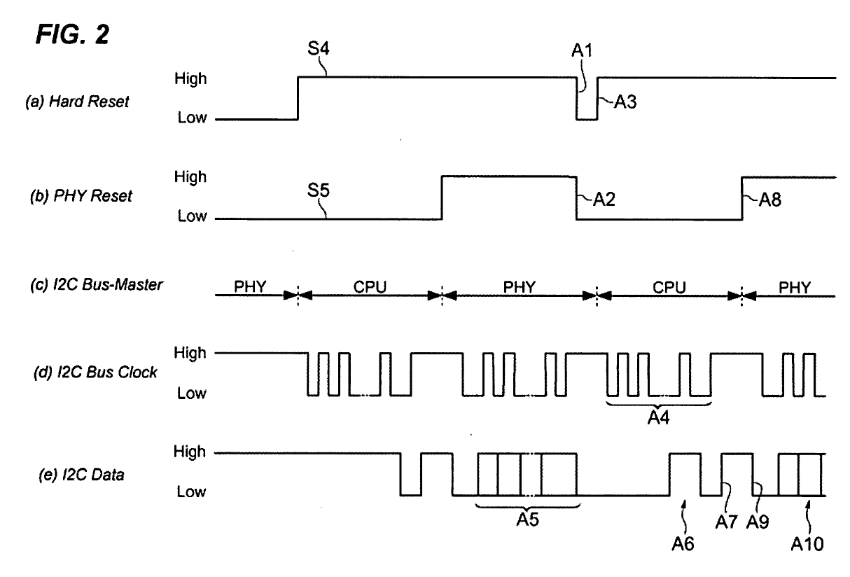

As illustrated in FIG. 2, asserting the hardware RESET S4 sent from the host system at A1, the CPU 13 sets the PHY RESET S5 to the PHY 7 at A2 and turns itself to the reset state. Subsequently, negating the hardware RESET S4 at A3, the CPU 13 initialized itself and switches itself to the master device in the I2C bus system as asserting the PHY RESET S5, where the CPU 13 automatically puts a dummy clock on the clock line of the I2C bus 15 as opening the data line of the bus 15.

The count of clocks of the dummy clock may be at least one bit more than bit counts for the data packet put on the I2C bus 15. The added one bit corresponds to a command to inform the completion of the sending clock. For instance, when one data packet constitutes of 8 bits, the count of the dummy clock may be more than 9 clocks. According to this procedure, even the I2C bus is interrupted during the memory sends the data A5, the memory may securely complete the sending of the rest data by the dummy clock provided from the CPU 13 and the I2C bus 15 may be safely opened.

Next, the CPU 13 completes the transmission on the I2C bus 15 by outputting the stop condition A7, moves its mode to the slave device on the I2C bus system 15, negates the PHY RESET S5 at A8 to release the RESET status of the PHY 7. At that time, the PHY 7 moves the master device in the I2C bus 15. The CPU 13 starts the monitoring of the transmitter section 3 and the receiver section 5 to prepare the calling from the PHY 7 to red those monitored information.

On the other hand, the PHY 7 that moves to the master device by resetting its RESET status, begins the initializing procedure, in which the PHY 7 sends the start condition A9 to read data A10 necessary to set the operation mode of the PHY 7 from the memory 9 via the I2C bus 15. In this instant, the data line of the I2C bus 15 is set in the high level because the CPU 15 releases the data line as described above, the PHY 7 securely generates the start condition A9 and the communication on the I2C bus may be securely started at A10. After the hardware RESET, the PHY 7 behaves as the master device, while, the CPU 13 and the memory 9 operate as the slave device on the I2C bus 15, which is a normal operation on the I2C bus 15.

The data link 1, in addition to the hardware RESET mentioned above, occasionally carries out the software RESET by receiving the software RESET command from the host system. Although the initializing process of the PHY 7 after the software RESET, the procedure above may be performed because, even such software RESET of the PHY 7, the I2C bus 15 puts the data from the memory 9.

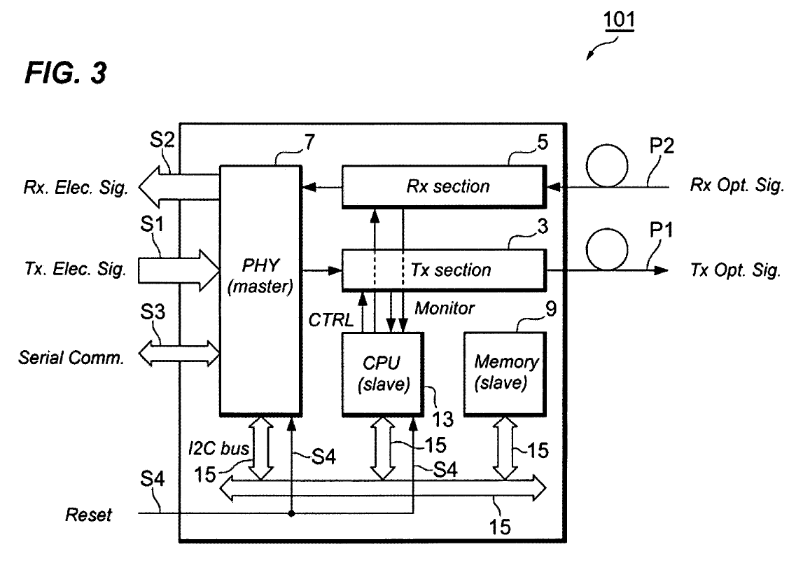

Next, the operation of the data link according to the present invention will be compared to a conventional data link 101 shown in FIG. 3. In the description below, the same element or block with those of the present invention shown in FIG. 1 will be referred by the same symbols or the numerals without overlapping explanations.

The comparable data link 101 has a distinguishable configuration from those of the present data link shown in FIG. 1 that the hardware RESET signal S4 received by the data link 101 is commonly drawn to the PHY 7 and the CPUB 13. That is, asserting the hardware RESET, the PHY 7 and the CPU 13 begins the initializing procedure independently. The CPU 13 initializes the control and the monitoring of the transmitter section 3 and the receiver section 5 and prepares itself for the request from the PHY 7 to read out these monitored information. On the other hand, the PHY 7 reads out the data from the memory via the I2C bus 15 to preset the PHY 7.

The data link 1 according to the invention or the conventional data link 101 occasionally receives the hardware RESET during the initialization procedure of the PHY 7, which is triggered by the software RESET. In another case, the data link may receive further hardware RESET during the initialization of the PHY 7 trigged by the hardware RESET. In those cases, the conventional data link 101 may bring problems described below.

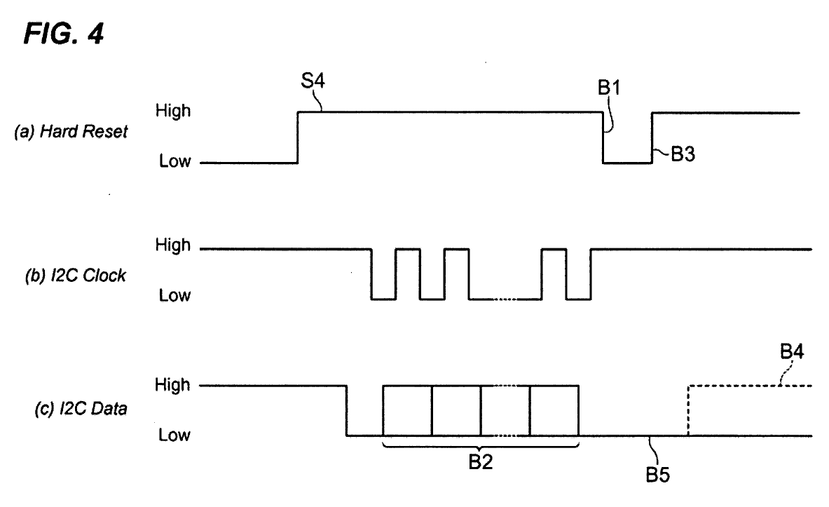

As shown in FIG. 4, the memory 9 outputs data B2 during the initialization of the PHY 7 to preset the PHY 7. When the further hardware RESET S4 is asserted at B1 during this initializing procedure, the clock is occasionally interrupted in its sending from the PHY 7 as the data B2 is left on the data line. Negating the hardware RESET S4 as the clock line and the data line of the I2C bus are left as they are, the PHY 7 can not generate the start condition of the I2C bus 15 when the memory 9 holds the data line of the I2C bus 15 in the LOW state B5, which makes the data link 101 unstable because the I2C bus can not operate normally.

On the other hand, referring FIG. 2 again where the time chart of the present optical data link 1 is illustrated, even if the hardware RESET S4 is doubly asserted at A1 during the initialization of the PHY 7, as described above, this RESET S4 is only provided to the CPU 13, and the CPU 13 temporarily becomes a master device on the I2C bus 15 instead of the PHY 7, and sends the dummy clocks on the clock line of the I2C bus 15 as keeping the reset status of the PHY 7 in advance to the accessing the memory 9 by the PHY 7.

Accordingly, even the I2C bus is stopped as the memory 9 puts the data A5 on the data line of the I2C bus 15, the memory 9 may complete the sending of the rest data A6 on the I2C line 15 by the dummy clock, and the I2C bus may be securely opened. Thus, because the initialization of the PHY 7 may be started as the I2C bus line is regularly opened, the preset A9 of the PHY 7 may be firmly generated, the reading A10 from the memory may be securely started, and the data link 1 may be protected from the hanging-up. Thus, the data link 1 may prevent the I2C bus system 15 from being inoperable even when the data link 1 receives the further hardware RESET S4 during the initialization of the PHY 7 trigged by the software RESET or the hardware RESET.

The foregoing is illustrative of the present invention, and is not to be construed as limiting thereof. The invention is defined by the following claims, with equivalents of the claims to be included therein.

I claim:

1. An optical data link able to be initialized triggered by a reset, comprising:
a controller for controlling an operation of the data link, the controller being able to receive the reset;
an IC for controlling a physical layer to communicate with an outside of the optical data link;
a memory to hold data to initialize the IC; and
an I2C bus system for coupling the controller, the memory and the IC the I2C bus system including a clock line and a data line,
wherein the controller temporarily behaves as a master device of the I2C bus system and the IC temporarily behaves as a slave device when the controller receive the reset, and
wherein the controller outputs a series of clocks on the clock line of the I2C bus system to sweep data left on the I2C bus.

2. A method for controlling a duplicate reset status of an optical data link that includes a controller, an IC for controlling a physical layer to communicate with the outside of the data link, a memory to hold data to initialize the IC and an I2C bus system to couple the controller, the IC and the memory, the I2C bus system including a data line and a clock line, the method comprising steps of:
(a) changing the controller to a master device of the I2C bus system and the IC to a slave device of the I2C bus system when the controller receives a reset signal from the outside of the data link;
(b) outputting a series of dummy clocks on the data line by the controller to clean up data rest on the data line; and
(c) changing the controller to the slave device and the IC to the master device of the I2C bus system.

3. The method according to claim 2,
wherein, at the step (b), the controller outputs at least one clock more than a number of clocks within a data packet sent on the I2C bus system.
